(19) United States
(12) Patent Application Publication
(10) Pub. No.: US 2025/0216282 A1
(43) Pub. Date: Jul. 3, 2025

(54) DEVICE AND METHOD FOR CAVITATION MONITORING OF HYDRAULIC SYSTEM

(71) Applicant: SHANDONG UNIVERSITY OF SCIENCE AND TECHNOLOGY, Qingdao (CN)

(72) Inventors: Qiang ZHANG, Qingdao (CN); Yang WANG, Qingdao (CN); Ying TIAN, Qingdao (CN); Shouji SUN, Qingdao (CN); Chunyong FAN, Qingdao (CN); Hengxuan LUAN, Qingdao (CN); Feng ZHOU, Qingdao (CN); Dongliang WEI, Qingdao (CN); Li YIN, Qingdao (CN); Hong ZHANG, Qingdao (CN); Bofeng CHANG, Qingdao (CN); Xin LIU, Qingdao (CN); Chenglong WANG, Qingdao (CN); Ya LIU, Qingdao (CN); Chao ZHANG, Qingdao (CN); Yongrui YANG, Qingdao (CN); Xiang FU, Qingdao (CN)

(21) Appl. No.: 19/021,565

(22) Filed: Jan. 15, 2025

Related U.S. Application Data
(63) Continuation of application No. PCT/CN2024/078476, filed on Feb. 26, 2024.

(30) Foreign Application Priority Data
Dec. 29, 2023 (CN) 202311852136.0

(51) Int. Cl. G01L 23/26; F17D 5/00

(52) U.S. Cl. CPC G01L 23/26; F17D 5/00

(57) ABSTRACT

A device for cavitation monitoring of a hydraulic system includes a branch pipe connected to a hydraulic pipe; a movable unit arranged in the branch pipe and in sliding fit with the branch pipe; and an acquisition unit arranged in the branch pipe and configured to acquire position information of the movable unit. The movable unit is configured such that when a gas filling amount in a medium in the hydraulic pipe changes, the movable unit moves along the branch pipe. The device also includes an information display unit connected to the acquisition unit and configured to analyze and display the position information acquired by the acquisition unit. The device also includes a buffer unit connected to one side of the movable unit close to the hydraulic pipe.

### CROSS-REFERENCE TO RELATED APPLICATIONS

This application is a continuation of PCT/CN2024/078476, filed on Feb. 26, 2024 and claims priority of Chinese Patent Application No. 202311852136.0, filed on Dec. 29, 2023, the entire contents of which are incorporated herein by reference.

### TECHNICAL FIELD

The disclosure belongs to the technical field of hydraulic cavitation monitoring, and in particular to a device and a method for cavitation monitoring of a hydraulic system.

### BACKGROUND

Cavitation refers to a phenomenon that in a liquid where the pressure of a certain flow region is lower than the saturated vapor pressure at that temperature, and the air dissolved in the liquid is separated and vaporized, thus generating cavitation. The instantaneous rupture of these bubbles releases a large amount of heat and pressure, and after an object is subjected to cavitation impact, the surface will experience deformation and material erosion, which is also called cavitation erosion. The occurrence of cavitation is harmful to the hydraulic system, so it is necessary to avoid cavitation phenomenon in the hydraulic system as much as possible.

In the prior art, it is inconvenient to monitor the cavitation phenomenon in the hydraulic system in real time, so a device and a method for cavitation monitoring of the hydraulic system are provided to solve the above problems.

### SUMMARY

In order to solve the above technical problems, the disclosure provides a device and a method for cavitation monitoring of a hydraulic system, which may realize that a branch pipe is connected to a hydraulic pipe, and a movable unit is arranged in the branch pipe; when the gas filling amount in the medium in the hydraulic pipe changes, the movable unit moves and feeds back to an acquisition unit to monitor cavitation in the hydraulic system in real time, so as to improve the reliability and stability of the hydraulic system.

In order to achieve the above objective, the present disclosure provides a device for cavitation monitoring of a hydraulic system, including:
a branch pipe connected to a hydraulic pipe;
a movable unit arranged in the branch pipe and is in sliding fit with the branch pipe;
where the movable unit is configured such that when a gas filling amount in a medium in the hydraulic pipe changes, the movable unit moves along the branch pipe; and
an acquisition unit arranged in the branch pipe and configured to acquire position information of the movable unit.

Further, the device further includes an information display unit connected to the acquisition unit and configured to analyze and display the position information acquired by the acquisition unit.

Further, the device further includes a buffer unit connected to one side of the movable unit close to the hydraulic pipe.

Further, the buffer unit includes a first piston in sliding fit with an inner wall of the branch pipe; and
a buffer spring arranged between the first piston and the movable unit, and two ends of the buffer spring are respectively fixed to the first piston and the movable unit.

Further, the device further includes a limiting unit arranged at one side of the movable unit close to the branch pipe, and the limiting unit is fixed on the inner wall of the branch pipe and configured to limit the movable unit.

Further, the limiting unit is a piston retaining ring fixed in the branch pipe.

Further, the device further includes a diversion pipe, two ends are respectively in communication with the hydraulic pipe, and the branch pipe is arranged on the diversion pipe and in communication with the diversion pipe.

Further, the acquisition unit is a pressure acquisition part, one end of the movable unit close to the pressure acquisition part is configured to apply pressure to the pressure acquisition part.

Further, the pressure acquisition part includes a pressure strain gauge fixed on an inner wall of an end face of the branch pipe.

A method for cavitation monitoring of a hydraulic system, adopting the device for cavitation monitoring of the hydraulic system above, and the operation steps include:
feeding pure water into the hydraulic pipe;
filling gases with different volume contents into the pure water, and recording first position information of the movable unit acquired by the acquisition unit; and
enabling the hydraulic pipe to work, acquiring second position information of the movable unit by the acquisition unit, and comparing the first position information with the second position information to determine the volume contents of the gases.

Compared with the prior art, the present disclosure has the following advantages and technical effects.

The branch pipe is connected to the hydraulic pipe, and the movable unit is arranged in the branch pipe. When the gas filling amount in the medium in the hydraulic pipe changes, the movable unit moves and feeds back to the acquisition unit to monitor the cavitation phenomenon in the hydraulic system in real time, thereby improving the reliability and stability of the hydraulic system.

### BRIEF DESCRIPTION OF THE DRAWINGS

The accompanying drawings, which constitute a part of this present disclosure, are used to provide a further understanding of this present disclosure. The illustrative embodiments of this present disclosure and their descriptions are used to explain this present disclosure, and do not constitute an improper limitation of this present disclosure. In the attached drawings:

FIG. 1 is a perspective view of a positional relationship between a housing and an information display unit.

FIG. 2 is a perspective view of a connection relationship between a hydraulic pipe and a branch pipe.

FIG. 3 is a sectional view of the branch pipe.

FIG. 4 is a schematic diagram of an initial position of a first piston in the branch pipe.

FIG. 5 is a schematic diagram of a central position of the first piston in the branch pipe.

FIG. 6 is a schematic view of a contact state between a top plate and a pressure strain gauge.

FIG. 7 is a flowchart of a method for cavitation monitoring of a hydraulic system according to the present disclosure.

### DETAILED DESCRIPTION OF THE EMBODIMENTS

In the following, the technical solutions in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features and advantages of the present disclosure more clearly understandable, the present disclosure will be further described in detail with the attached drawings and specific embodiments.

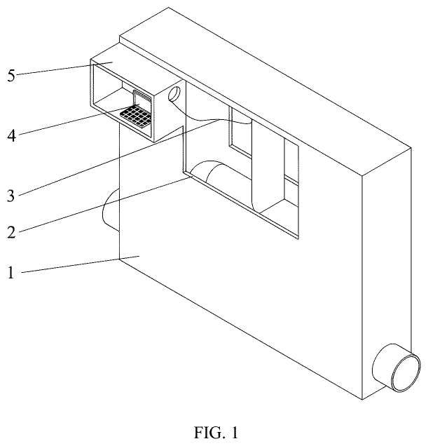

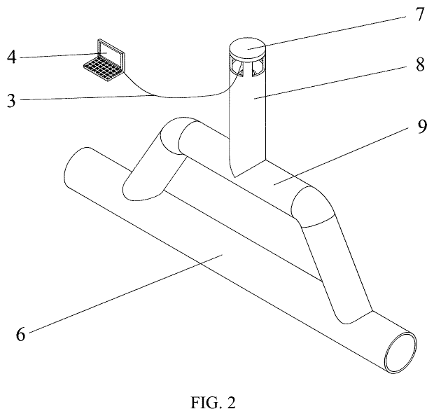

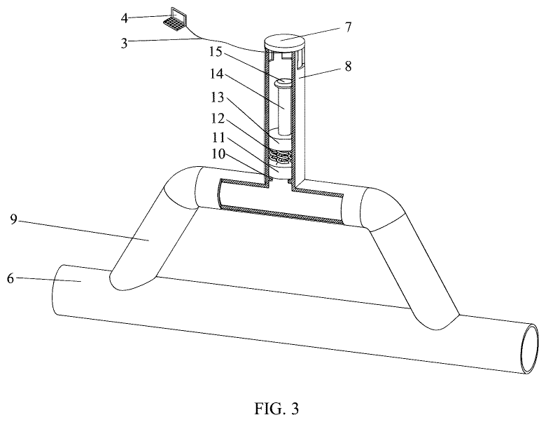

As shown in FIG. 1 to FIG. 6, the disclosure provides a device for cavitation monitoring of a hydraulic system. The device includes a branch pipe 8, a movable unit 13 and an acquisition uni. The branch pipe 8 is connected to the hydraulic pipe 6; the movable unit 13 is arranged in the branch pipe 8 and is in sliding fit with the branch pipe 8, and the movable unit 13 is configured to move along the branch pipe 8 when the gas filling amount in the medium within the hydraulic pipe 6 changes.

Specifically, the branch pipe 8 is connected to the hydraulic pipe 6, and the movable unit 13 is arranged in the branch pipe 8. When the gas filling amount in the medium in the hydraulic pipe 6 changes, the gas dissolved in the medium is separated and vaporized, and the medium pushes the movable unit 13 to move in the branch pipe 8, and the acquisition unit acquires the changed position information of the movable unit 13, thereby realizing real-time monitoring.

Since the vaporization of gas after separation from medium tends to move upward, the branch pipe 8 is preferably connected directly above or obliquely above the hydraulic pipe 6, so that the movable unit 13 moves upward under the push of the medium.

In a specific embodiment of the present disclosure, the movable unit 13 is a second piston in sliding fit with the branch pipe 8. After the medium is filled into the branch pipe 8, it pushes the second piston to move and is monitored by the acquisition unit.

Further, a piston rod 14 is fixed to one end of the second piston far away from the hydraulic pipe 6, and a top plate 15 is fixed at the other end of the piston rod 14. The piston rod 14 is used in conjunction with the top plate 15. The existence of the piston rod 14 may shorten the distance between the top plate 15 and the acquisition unit, and the existence of the top plate 15 may facilitate the acquisition unit to acquire position information. Therefore, when the acquisition unit works, the position information of the movable unit 13 may be obtained by acquiring the position information of the top plate 15.

An acquisition unit is disposed in the branch pipe 8 and is configured to acquire position information of the movable unit 13.

Specifically, the acquisition unit is fixed in the branch pipe 8, and is used to monitor the position of the movable unit 13 in real time.

This embodiment further includes an information display unit 4, which is connected to the acquisition unit and is configured to analyze and display the position information acquired by the acquisition unit.

Specifically, the acquisition unit is connected to the information display unit 4 through the transmission line 3, so that the information acquired by the acquisition unit may be sent to the information display unit 4, and the cavitation phenomenon may be converted into visual data, and the liquid pressure of the hydraulic system may be converted into digital signals through the acquisition unit, which greatly improves the reliability and stability of the hydraulic system.

The information display unit 4 is used to store and display the data fluctuation generated by the acquisition unit, and at the same time compare the big data to analyze the cavitation degree and time of the hydraulic system.

In a specific embodiment of the present disclosure, the information display unit 4 is a control and display device, or other devices that may analyze the information transmitted by the acquisition unit and display.

Further, the device also includes a housing 1, which is wrapped outside the hydraulic pipe 6 and the branch pipe 8. The housing 1 is used to protect the hydraulic pipe 6 and the movable unit 13.

Further, the housing 1 is provided with a hanging window 2. The existence of the hanging window 2 is convenient for observing the working condition of the branch pipe 8.

Further, a monitoring protection box 5 is fixed on the housing 1. The monitoring protection box 5 may be fixed on the housing 1 by bolt connection, and the monitoring protection box 5 is used to place and protect the information display unit 4.

In this embodiment, the device also includes a buffer unit, which is connected to the side of the movable unit 13 close to the hydraulic pipe 6.

Specifically, the buffer unit is connected to the movable unit 13, and the buffer unit may be replaced according to the actual different working conditions, so as to play a buffering role and slow down the pressure of the hydraulic system.

In a specific embodiment of the present disclosure, the buffer unit includes a first piston 11 and a buffer spring 12. The first piston 11 is in sliding fit with the inner wall of the branch pipe 8. The buffer spring 12 is arranged between the first piston 11 and the movable unit 13, and its two ends are respectively fixed to the first piston 11 and the movable unit 13.

The end of the movable unit 13 close to the hydraulic pipe 6 is connected to the buffer spring 12, and the other end of the buffer spring 12 is connected to a first piston 11. The first piston 11 is connected to the branch pipe 8 in a sealed way, and the first piston 11 directly contacts with the fluid medium in the hydraulic system, so that the pressure is transmitted to the movable unit 13 through the buffer spring 12, thereby realizing the buffering of the movable unit 13.

Alternatively, the buffering unit adopts other buffering structures, taking the realization of buffering for the movable unit 13 as the standard.

In this embodiment, the device also includes a limiting unit, which is arranged at the side of the movable unit 13 near the branch pipe 8, and the limiting unit is fixed on the inner wall of the branch pipe 8 and is configured to limit the movable unit 13.

Specifically, when the movable unit 13 is provided with the buffer unit, the limiting unit is arranged at the side of the buffer unit close to the hydraulic pipe 6 to prevent the buffer unit from driving the movable unit 13 away from the branch pipe 8.

In this embodiment, the limiting unit is a piston retaining ring 10 fixed in the branch pipe 8.

The piston retaining ring 10 may be installed in the branch pipe 8 by welding for preventing the first piston 11 from moving towards of the hydraulic pipe 6.

Alternatively, the limiting unit may be a protrusion, a plate and other structures that play a limiting role.

In this embodiment, the device also includes a diversion pipe 9. Two ends of the diversion pipe 9 are respectively in communication with the hydraulic pipe 6, and the branch pipe 8 is arranged on and in communication with the diversion pipe 9.

Specifically, the diversion pipe 9 preferably has a flow passage segment parallel to the hydraulic pipe 6, and the branch pipe 8 is arranged on the flow passage segment. The diversion pipe 9 is connected to the hydraulic pipe 6 by welding to lead out the fluid in the hydraulic pipe 6, and the branch pipe 8 is connected to the diversion pipe 9 by welding to protect the monitoring device.

In one embodiment of the present disclosure, the acquisition unit is a pressure acquisition part, and the end of the movable unit 13 close to the pressure acquisition part is configured to apply pressure to the pressure acquisition part. The pressure acquisition part includes a pressure strain gauge 16 fixed on the inner wall of the end face of the branch pipe 8.

Specifically, when the acquisition unit is a pressure acquisition part, the top plate 15 contacts the pressure strain gauge 16, and the pressure strain gauge 16 acquires the pressure exerted by the top plate 15 and transmits the pressure information to the information display unit 4, thereby realizing the function of converting the pressure signal into the digital signal.

Further, the device also includes a pressure strain gauge mounting plate 7, which is fixed at the end of the branch pipe 8 away from the hydraulic pipe 6 through multiple supporting plates, and the pressure strain gauge 16 is fixed on the pressure strain gauge mounting plate 7.

In another embodiment of the present disclosure, the acquisition unit is a distance acquisition part, and one end of the movable unit 13 near the distance acquisition part is configured to determine the distance between the distance acquisition part and the movable unit 13; the distance acquisition part includes a distance sensor.

Specifically, the pressure strain gauge 16 is replaced by the distance sensor. By monitoring the real-time position between the top plate 15 and the distance sensor in real time and transmitting the distance information to the information display unit 4, the function of converting the distance signal into the digital signal is achieved.

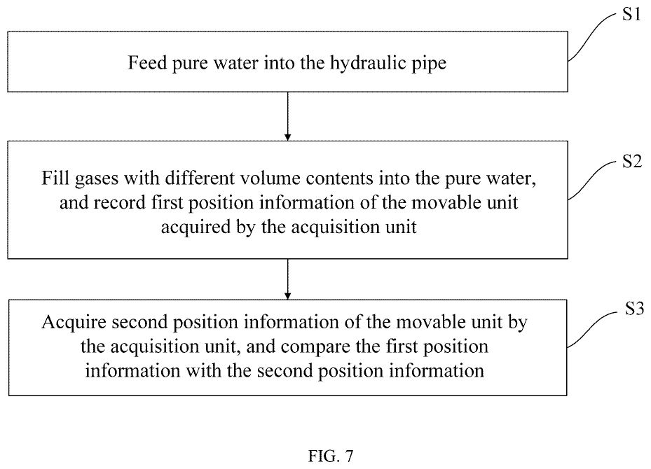

A method for cavitation monitoring of a hydraulic system adopts the device for cavitation monitoring of the hydraulic system, and the method includes the following operation steps, as shown in FIG. 7.

Pure water is fed into the hydraulic pipe 6, gases with different volume contents are filled into the pure water, and first position information of the movable unit 13 acquired by the acquisition unit is recorded.

Specifically, before the formal work of the hydraulic system begins, it is necessary to establish a comparison database, which is based on multiple groups of data collection experiments. At the beginning, the hydraulic system works in pure water condition to ensure that there is no cavitation in the system. Relevant data under this condition are collected and stored in the database after processing. Then, gases with volume contents ranging from 1% to 10% are respectively introduced into the system, so that the system may generate cavitation phenomena of different degrees, data under different working conditions is monitored and collected. After processing, the data is formed into the first position information and stored in the database. The relevant data is organized in the database and is connect to the information display unit 4, so as to facilitate the direct retrieval of data in the subsequent work.

The hydraulic pipe 6 works, and the acquisition unit acquires the second position information of the movable unit 13, and the first position information is compared with the second position information to determine the volume contents of the gases.

Specifically, when the hydraulic system starts to work, and pure water is introduced into the hydraulic pipe 6. The pure water enters the branch pipe 8 through the diversion pipe 9 and impacts the first piston 11. Under the impact of liquid pressure, the first piston 11 moves upward along the branch pipe 8. Correspondingly, the first piston 11 pushes the buffer spring 12, and the buffer spring 12 drives the piston rod 14 and the top plate 15 to move upward. The buffer spring 12 absorbs part of the energy of the liquid, playing a better buffering role.

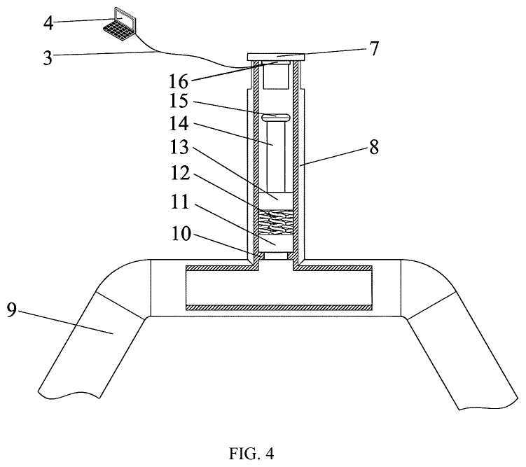

Specifically, referring to FIG. 4, at the beginning, the first piston 11 is not impacted by liquid, and the first piston 11 is located at the piston retaining ring 10 at the bottommost end of the branch pipe 8.

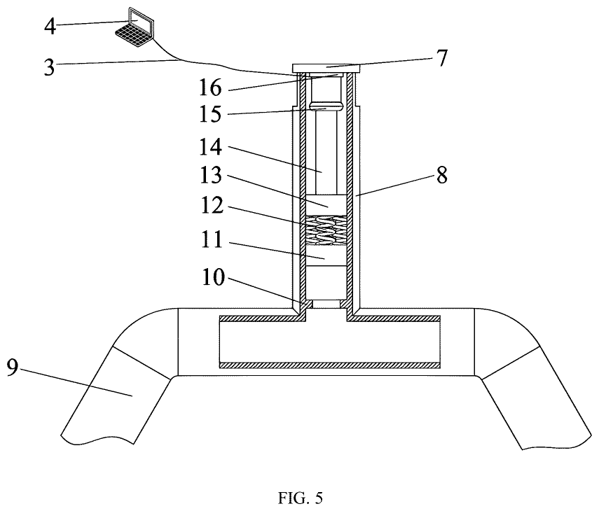

Referring to FIG. 5, after the pure water is introduced, under the impact of liquid pressure, the first piston 11 moves upward, thus driving the buffer spring 12, the movable unit 13, the piston rod 14 and the top plate 15 to move upward together, and the first piston 11 is located in the middle position in the branch pipe 8.

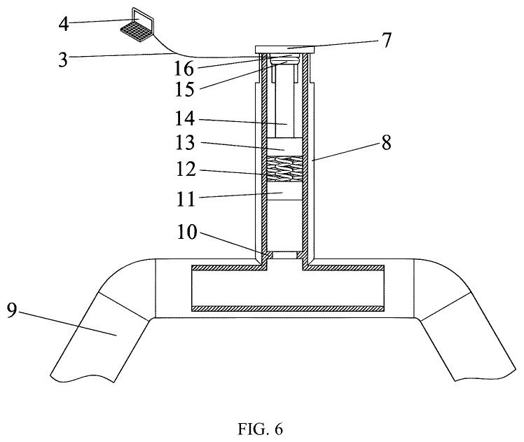

As shown in FIG. 6, under the impact of liquid pressure, the first piston 11, the buffer spring 12, the movable unit 13, the piston rod 14 and the top plate 15 continue to move upward until the top plate 15 touches the pressure strain gauge 16.

Among them, the pressure transmission path in the system is as follows: the first piston 11, the buffer spring 12, the movable unit 13, the piston rod 14, the top plate 15 and the pressure strain gauge 16. With the occurrence of cavitation, the liquid contains gases with different volume fractions, and the liquid pressure will change accordingly. Under the impact of the top plate 15, the pressure strain gauge 16 generates corresponding data changes, and the data is transmitted to the information display unit 4 through a transmission line. By comparing the data with the big data of the computer system, if a sudden and drastic data fluctuation is detected, or if the data fluctuations are basically consistent with the data under cavitation conditions, it is considered that cavitation has occurred in the system, so as to judge the degree and corresponding time of cavitation in the hydraulic system.

The above is only the preferred embodiment of the present disclosure, but the protection scope of the present disclosure is not limited to this. Any change or replacement that may be easily thought of by a person skilled in the art within the technical scope disclosed in the present disclosure should be included in the protection scope of the present disclosure. Therefore, the protection scope of the present disclosure should be based on the protection scope of the claims.

What is claimed is:

1. A device for cavitation monitoring of a hydraulic system, comprising:
a branch pipe connected to a hydraulic pipe;
a movable unit arranged in the branch pipe and in sliding fit with the branch pipe, wherein the movable unit is configured such that when a gas filling amount in a medium in the hydraulic pipe changes, the movable unit moves along the branch pipe; and
an acquisition unit arranged in the branch pipe and configured to acquire position information of the movable unit.

2. The device for cavitation monitoring of the hydraulic system according to claim 1, further comprising an information display unit connected to the acquisition unit and configured to analyze and display the position information acquired by the acquisition unit.

3. The device for cavitation monitoring of the hydraulic system according to claim 1, further comprising a buffer unit connected to one side of the movable unit close to the hydraulic pipe.

4. The device for cavitation monitoring of the hydraulic system according to claim 3, wherein the buffer unit comprises:
a first piston in sliding fit with an inner wall of the branch pipe; and
a buffer spring arranged between the first piston and the movable unit, wherein two ends are respectively fixed to the first piston and the movable unit.

5. The device for cavitation monitoring of the hydraulic system according to claim 1, further comprising a limiting unit arranged at one side of the movable unit close to the branch pipe, wherein the limiting unit is fixed on an inner wall of the branch pipe and configured to limit the movable unit.

6. The device for cavitation monitoring of the hydraulic system according to claim 5, wherein the limiting unit is a piston retaining ring fixed in the branch pipe.

7. The device for cavitation monitoring of the hydraulic system according to claim 1, further comprising a diversion pipe, wherein two ends are respectively in communication with the hydraulic pipe, and the branch pipe is arranged on the diversion pipe and in communication with the diversion pipe.

8. The device for cavitation monitoring of the hydraulic system according to claim 1, wherein the acquisition unit is a pressure acquisition part, and one end of the movable unit close to the pressure acquisition part is configured to apply pressure to the pressure acquisition part.

9. The device for cavitation monitoring of the hydraulic system according to claim 8, wherein the pressure acquisition part comprises a pressure strain gauge fixed on an inner wall of an end face of the branch pipe.

10. A method for cavitation monitoring of a hydraulic system, adopting the device for cavitation monitoring of the hydraulic system according to claim 1, wherein operation steps comprise:
feeding pure water into the hydraulic pipe;
filling gases with different volume contents into the pure water, and recording first position information of the movable unit acquired by the acquisition unit; and
enabling the hydraulic pipe to work, acquiring second position information of the movable unit by the acquisition unit, and comparing the first position information with the second position information to determine the volume contents of the gases.
